(19) United States
(12) Patent Application Publication
(10) Pub. No.: US 2010/0165184 A1
(43) Pub. Date: Jul. 1, 2010

(54) Camera lens assembly

(75) Inventors: Jong-Ho Park, Yongin-si (KR); Kun-Hak Lee, Hwaseong-si (KR); Hyun-Sik Shim, Yongin-si (KR); Yong-Jin Choi, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/655,441

(22) Filed: Dec. 30, 2009

(30) Foreign Application Priority Data
Dec. 31, 2008 (KR) 10-2008-0138212

(51) Int. Cl. H04N 5/225

(52) U.S. Cl. 348/374; 348/E05.024

(57) ABSTRACT

Disclosed is a camera lens assembly, including a fixed frame; a rotation frame disposed in the fixed frame and configured to rotate about a first axis; an image sensor frame provided in the rotation frame and configured to rotate about a second axis; a first driving part installed in the fixed frame and configured to rotate the rotation frame; and a second driving part installed in the rotation frame and configured to rotate the image sensor frame, wherein the second axis extends in a direction perpendicular to the first axis.

### CROSS-REFERENCE TO RELATED APPLICATION(S) AND CLAIM OF PRIORITY

The present application is related to and claims the priority under 35 U.S.C. §119(a) of an application entitled “Camera Lens Assembly” filed in the Korean Industrial Property Office on Dec. 31, 2008 and assigned Serial No. 10-2008-0138212, the contents of which are hereby incorporated by reference.

### TECHNICAL FIELD OF THE INVENTION

The present invention relates to a camera lens assembly, and more particularly to a camera assembly having a pan-tilt structure which can be installed in a portable communication device such as a cellular phone or a personal digital assistant (PDA), or a portable electronic device such as a laptop computer or the like.

### BACKGROUND OF THE INVENTION

In general, a camera lens assembly has been installed in a typical photographing device like a camera, a closed-circuit camera for security purposes or the like, which has been used to take an image of an object to be photographed or a mobile image or the like. With the development of image sensor technology, as a core component of the camera lens assembly, which is designed to transform the image of the object into an electrical signal, a digital camera has come into wide spread use. Moreover, an image sensor is also installed in a portable communication device or a portable electronic device such as a laptop computer.

Even though the closed-circuit camera in the prior art is mounted or secured to a predetermined location, the image sensor is disposed such that it can take images in various directions in order to provide a broad photographing area. Taking images in various directions can be achieved by installing the image sensor to be rotatable in various directions using a pan-tilt structure. Such a pan-tilt structure is disclosed in US patent publication No. 2006/0039687 or the like.

Such a conventional pan-tilt structure includes a supporting part and a driving part for rotating a pan direction, and a supporting part and a driving part for rotating a tilt direction. Each driving part is configured to rotate the supporting part by transferring the power of a driving motor using an expensive driving motor, such as a DC motor, a stepper motor, a servo motor or the like, and a timing belt, such as a pulley or the like. The closed-circuit camera is provided with such a driving motor, the supporting part, and a power transmission system or the like within a dome-shape structure, which protects the supporting part and the driving part as described above.

However, the conventional pan-tilt structure as described above has limitations in miniaturizing its size. More specifically, since various kinds of motors form the driving part and power transmission systems to transfer the driving power also take up considerable space, it has drawbacks in that it is difficult to miniaturize the pan-tilt structure and further consumes a lot of electric power to operate the driving motor. Moreover, it also has drawbacks in that because of the difficulty in miniaturizing the device, it can be easily exposed, thereby lowering the security of the device.

Further, since it is difficult to miniaturize the conventional pan-tilt structure, the camera assembly cannot be employed in the portable communication device such as a cellular phone or the like.

### SUMMARY OF THE INVENTION

To address the above-discussed deficiencies of the prior art, it is a primary object to provide a camera lens assembly using a miniaturized pan-tilt structure, so as to improve the security of a closed-circuit camera or the like.

Also, the present invention provides a camera lens assembly having a pan-tilt structure, which can also be employed in a portable communication device such as a cellular phone or the like.

In accordance with an aspect of the present invention, there is provided a camera lens assembly, including: a fixed frame; a rotation frame disposed in the fixed frame and configured to rotate about a first axis; an image sensor frame provided in the rotation frame and configured to rotate about a second axis; a first driving part installed in the fixed frame and configured to rotate the rotation frame; and a second driving part installed in the rotation frame and configured to rotate the image sensor frame, wherein the second axis extends in a direction perpendicular to the first axis.

In the camera assembly, an image sensor is mounted on the image sensor frame, and the light axis of the image sensor extends in a direction perpendicular to the second axis.

Further, in an initial state when the rotation frame is not rotated, the rotation frame is surrounded by the fixed frame, wherein the image sensor frame is surrounded by the rotation frame, and wherein the light axis of the image sensor, the first axis, and the second axis are configured in a direction perpendicular to each other.

The first driving part includes a first piezoelectric element disposed in the fixed frame; a first driving shaft installed on the fixed frame, wherein the first driving shaft is configured to linearly move back and forth in a direction perpendicular to the first axis at a location spaced apart from the first axis; and a first moving member coupled to the first driving shaft, wherein the first moving member is configured to move along the first driving shaft upon activation of the first piezoelectric element, wherein the first moving member is connected with the rotation frame and is configured to rotate the same while moving along the first driving shaft.

The first driving part further includes a first supporting member which extends in a direction perpendicular to the first axis from the fixed frame to support the first driving shaft.

The second driving part includes a second piezoelectric element disposed in the fixed frame; a second driving shaft installed on the rotation frame, wherein the second driving shaft is configured to linearly move back and forth in a direction perpendicular to the second axis at a location spaced apart from the second axis; and a second moving member coupled to the second driving shaft, wherein the second moving member is configured to move along the second driving shaft upon activation of the second piezoelectric element, wherein the second moving member is connected with the image sensor frame and is configured to rotate the same while moving along the second driving shaft.

Further, the second driving part further includes a second supporting member which extends in a direction perpendicular to the second axis from the rotation frame to support the second driving shaft.

The camera assembly may further include a tilt sensor installed on the image sensor frame. The tilt sensor is a bi-axial tilt sensor and is configured to detect a rotational position of the image sensor frame with respect to the first and second axes, respectively.

The first driving part further includes a first magneto-resistance sensor installed on the first supporting member and a first magnetic substance mounted on the first moving member, wherein the first magneto-resistance sensor is configured to detect the position of the first magnetic substance to detect the rotational position of the image sensor frame with respect to the first axis.

The second driving part further includes a second magneto-resistance sensor installed on the second supporting member and a second magnetic substance mounted on the second moving member, wherein the second magneto-resistance sensor is configured to detect the position of the second magnetic substance to detect the rotational position of the image sensor frame with respect to the second axis.

In the camera lens assembly having the construction as described above, the image sensor is configured to rotate about two rotation axes using frame-type rotation members, which makes it easy to reduce the volume of the camera lens assembly and enables the camera lens assembly to have a fan-tilt structure. Specifically, one of frame-type rotation members is configured to rotatably receive and surround the other member, thereby enabling the reduction of the fan-tilt structure. As a result, it is possible to minimize the exposure of the camera lens assembly when it is installed at a place requiring security.

Further, the reduction in the volume of the fan-tile structure can reduce the driving force required by the fan-tilt operation, which enables use of piezo-electric element as a driving device, thereby reducing the power consumption. Further, the size reduction of the fan-tile structure and the power consumption reduction in driving the structure enable even a mobile communication apparatus, such as a cellular phone, to be equipped with a camera lens assembly having a fan-tile structure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view illustrating a portable communication device equipped with a camera lens assembly in accordance with a preferred embodiment of the present invention;

FIG. 2 is an enlarged perspective view illustrating the camera lens assembly as shown in FIG. 1;

FIG. 3 is a plan view, a front view and a side elevational view, respectively, illustrating the camera lens assembly as shown in FIG. 2;

FIG. 4 is a perspective view illustrating operations of the camera lens assembly as shown in FIG. 2; and

FIG. 5 is a side elevational view illustrating operations of the camera lens assembly as shown in FIG. 2.

### DETAILED DESCRIPTION OF THE INVENTION

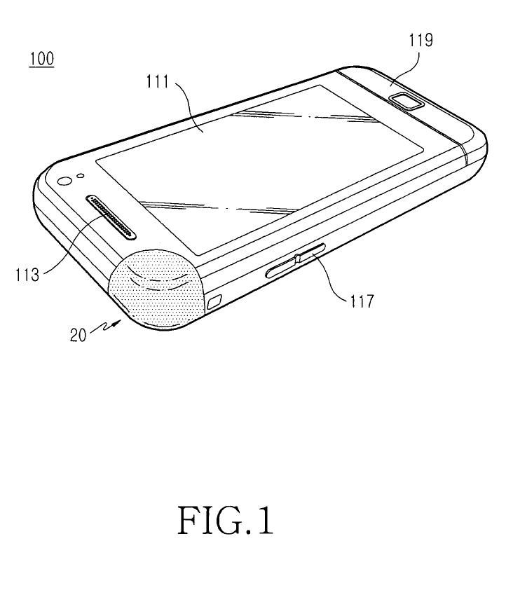

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged camera lens assembly.

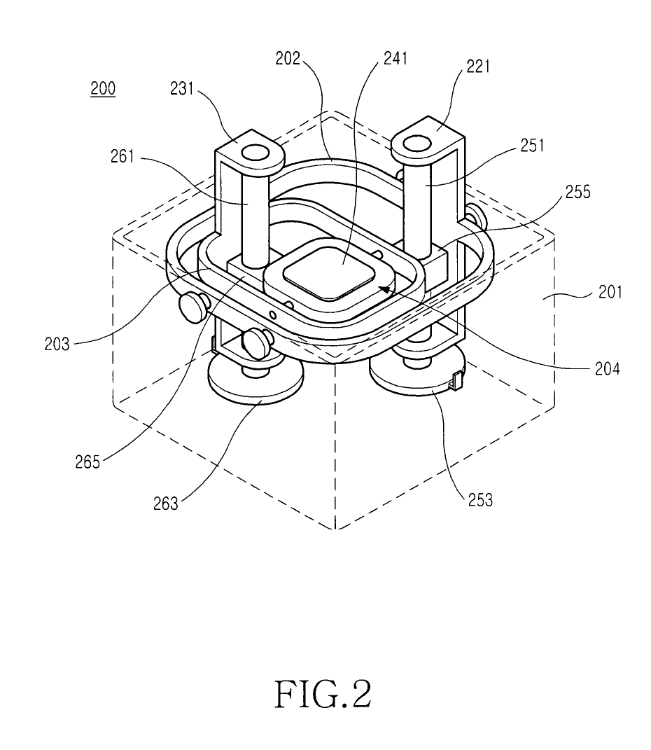

FIG. 1 shows a portable communication device 100, more specifically a cellular phone having a camera lens assembly 200 in accordance with a preferred embodiment of the present invention. FIG. 2 shows the camera lens assembly 200 which is adapted to be installed in the portable communication device 100.

The portable communication device 100 is provided with a display device 111 at one surface thereof. A speaker device 113 is installed at one side of the display device 111, and a keypad 119 which is used to perform a start/finish function of communication or the like is provided at the other side of the display device 111. Moreover, the portable communication device 100 is provided with a microphone (not shown) for voice communication adjacent to the keypad 119. The display device 111 is constructed as a touch screen to embody a virtual keypad on the screen, which allows a user to input numerals or letters as desired. The portable communication device 100 is further provided with a two-way key 117 at one side thereof, which can be used to adjust the volume of a sound outputted from the speaker device 113 or move a menu indicated on the display device 111.

The camera lens assembly 200 is installed in a dome 20 which is mounted at one side of the portable communication device 100. The dome 20 is made from a transparent material, such as a reinforced glass, acryl or the like, which protects the camera lens assembly 200 as well as assures the photographing operation of the same.

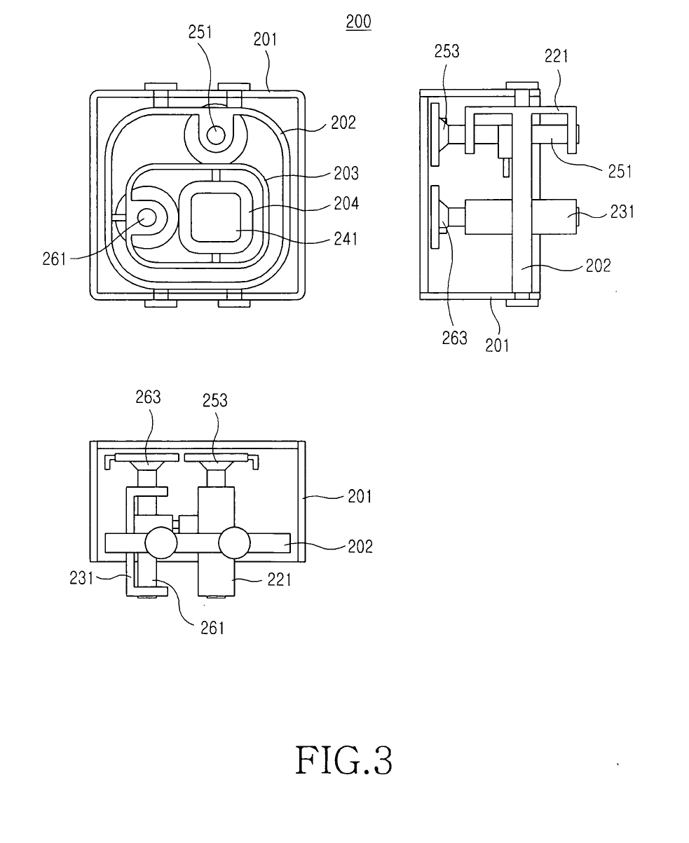

FIG. 3 shows a plan view, a front view, and a side elevational view, respectively, of the camera lens assembly 200. Referring to FIGS. 2 and 3, the camera lens assembly 200 includes a fixed frame 202, a rotation frame 203, an image sensor frame 204, a first driving part, and a second driving part. The camera lens assembly 200 may further include a separate housing 201 for receiving these components above.

The housing 201, as indicated in a phantom line in FIG. 2, is mounted to be secured to one corner of the portable communication device 100, to which the fixed frame 202 is fixedly secured within the housing 201. The fixed frame 202 is mounted and fixed to the housing 201 so as to support the rotation frame 203.

The rotation frame 203 is disposed within the fixed frame 202 in a state capable of rotating about a first axis A1, wherein the opposite ends of the rotation frame 203 are rotatably supported in the opposite inner sides of the fixed frame 202. In an initial state when the rotation frame 203 is not rotated, the rotation frame 203 is surrounded by the fixed frame 202.

The image sensor frame 204 is provided within the rotation frame 203 in a state capable of rotating about a second axis A2, wherein the opposite ends of the image sensor frame 204 are rotatably supported at the inner sides of the rotation frame 203. As shown, the second axis A2 extends in a direction perpendicular to the first axis A1. The rotation frame 203 is rotated about the first axis A1 on the fixed frame 202, while the image sensor frame 204 is rotated about the first axis A1 together with the rotation frame 203. In an initial state when the image sensor frame 204 is not rotated, the image sensor frame 204 is surrounded by the rotation frame 203.

An image sensor 241 of the camera lens assembly 200 is mounted on the image sensor frame 204, wherein the light axis of the image sensor 241 extends in a direction perpendicular to the second axis A2. Since the image sensor frame 204 is rotated about the first axis A1 along with the rotation frame 203 as well as being rotated about the second axis A2 on the rotation frame 203, the image sensor 241 is also rotated with respect to the first and second axes A1 and A2. Hence, the camera lens assembly 200 can take an image in various directions.

Meanwhile, the first and second driving parts are designed to rotate the rotation frame 203 and the image sensor frame 204, respectively. In other words, the first driving part rotates the rotation frame 203 with respect to the fixed frame 202, while the second driving part rotates the image sensor frame 204 with respect to the rotation frame 203.

The first driving part includes a first piezoelectric element 253, a first driving shaft 251 and a first moving member 255. In order to install the first driving part, more specifically, the first driving shaft 251, the fixed frame 202 may be provided with a first supporting member 221. The first supporting member 221 extends in a direction perpendicular to the first axis A1 at a location spaced apart from the first axis A1, whose opposite ends are in the form of a bent-shape facing each other.

The first piezoelectric element 253 is mounted on the fixed frame 202, more specifically, at one end of the first supporting member 221, and begins to vibrate upon application of an operation signal. One end of the first driving shaft 251 is disposed on the first piezoelectric element 253, and the other end of the first driving shaft 251 is supported at the other end of the first supporting member 221 while it is capable of linearly moving back and forth. As such, when the operational signal is applied to the first piezoelectric element 253 to vibrate the same, the first driving shaft 251 starts to linearly move back and forth.

The first moving member 255 is provided to slide along the first driving shaft 251. The first piezoelectric element 253 repeats a rapid movement in one direction and a slow movement in a reverse direction depending upon the applied operational signal. In accordance with such a movement of the first piezoelectric element 253, the first driving shaft 251 also repeats the rapid and slow movements in turn. When the first driving shaft 251 moves rapidly, the first moving member 255 maintains a predetermined position in the portable communication device 100 by its inertia. In contrast, when the first driving shaft 251 moves slowly, the first moving member 255 moves together with the first driving shaft 251 in the portable communication device 100 by a static friction force with the first driving shaft 251. Accordingly, the first moving member 255 can move along the extended direction of the first driving shaft 251.

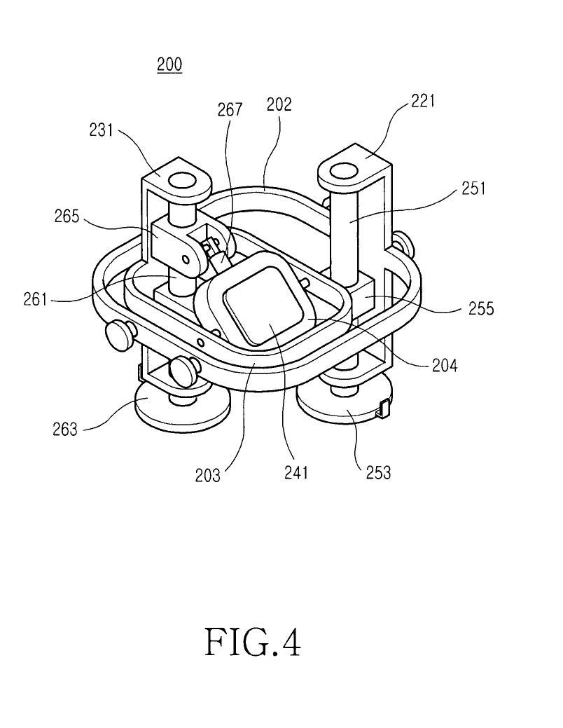

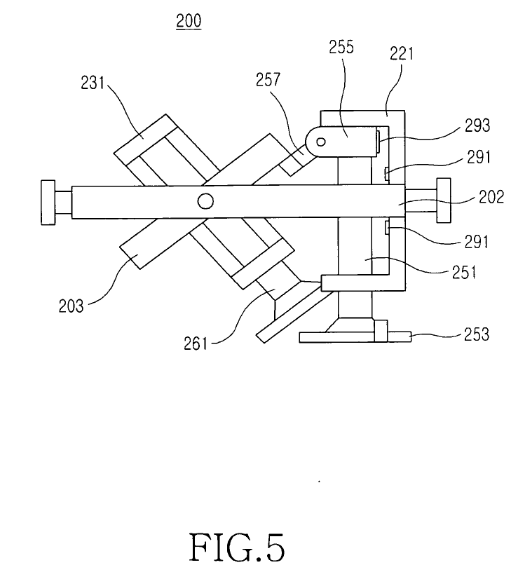

Further, the first moving member 255 is connected with the rotation frame 203 through a crank structure. When the first moving member 255 moves along the first driving shaft 251, the rotation frame 203 is then rotated about the first axis A1. The details of the crank structure will be described hereinbelow with reference to FIGS. 4 and 5.

Meanwhile, the second driving part includes a second piezoelectric element 263, a second driving shaft 261 and a second moving member 265. In order to install the second driving part, the rotational frame 203 may be provided with a second supporting member 231, which extends in a direction perpendicular to the second axis A2, at a location spaced apart from the second axis A2. The second driving part is designed to rotate the image sensor 241 about the second axis A2 on the rotation frame 203, which has the same constructional principle as that of the first driving part for rotating the rotational frame 203 about the first axis A1 on the fixed frame 202. Therefore, since the construction of the second driving part can be easily conceivable from that of the first driving part for those skilled in the art, the detailed description thereof will be omitted.

Operations of rotating the photographing direction of the image sensor 241 in the camera lens assembly 200 will be described with reference to FIGS. 4 and 5 hereinbelow.

FIGS. 2 and 3 show the initial state where both the rotation frame 203 and the image sensor frame 204 are not rotated.

In an initial state, the image sensor frame 204 is surrounded by the rotation frame 203, while the rotation frame 203 is surrounded by the fixed frame 202. At this moment, the light axis of the image sensor frame 204 is arranged in a direction perpendicular to the first and second axes A1 and A2, respectively.

FIG. 4 shows a state where the image sensor frame 204 is rotated about the second axis A2 by the operation of the second driving part. As mentioned hereinabove, the second moving member 265 is connected with the image sensor frame 204 through the crank structure. In this embodiment, one end of the crank structure, which connects the second moving member 265 with the image sensor 241, is pivotably coupled to the second moving member 265, while the other end thereof is composed of a crank member 267 which is coupled to the image sensor frame 204 so as to be linearly displaceable.

FIG. 5 shows a state where the rotation frame 203 is rotated about the first axis A1 upon the operation of the first driving part. One end of the crank member 257, which connects the first moving member 255 with the rotation frame 203, is pivotably coupled to the first moving member 255. In contrast, the other end of the crank member 257 is coupled to the rotation frame 203, which is capable of linearly moving therewith.

The first and second driving parts as described above can be operated independently or simultaneously, which makes it possible to adjust the photographing direction of the image sensor 241 in various ways.

Meanwhile, in order to rotate the image sensor 241 in a desired direction for photographing an image, it needs to detect a position where the image sensor 241 is rotated and then stopped.

With the pan-tilt construction in the prior art, an encoder was used to detect the position of the image sensor being rotated when a DC motor or the like was employed as the driving part. Further, when a stepper motor was used as the driving part, the rotational position of the image sensor could be detected using the number of steps that the stepper motor had been operated.

However, in the pan-tilt construction of the camera lens assembly 200 in accordance with the present invention, a tilt sensor or a magneto-resistance sensor is employed to detect the photographing direction of the image sensor 241.

To detect the position where the image sensor 241 is rotated and stopped, it is preferable to dispose a bi-axial tilt sensor (not shown) together with the image sensor 241 on the image sensor frame 204. The reason for this is to detect the exact position of the image sensor 241 by making the position between the tilt sensor and the image sensor 241 as close as possible, so that it can minimize positional differences between the tilt sensor and the image sensor 241. Even if the tilt sensor is installed more or less away from the image sensor 241, it can be easily understood for those skilled in the art that the exact position of the image sensor 241 can be calculated using the positional difference between the tilt sensor and the image sensor 241, provided that the tilt sensor is disposed together with the image sensor 241 on a structure where the image sensor 241 is installed, i.e., the image sensor frame 204.

In the meantime, a method for calculating the position of the image sensor 241 according to the positional difference between the tilt sensor and the image sensor 241 can be performed in various ways depending on standards of the image sensor frame 204, moving trajectories of the tilt sensor and the image sensor 241 according to the rotation of the image sensor frame 204, installation positions of the tilt sensor and the image sensor 241 or the like, which can be properly selected by those skilled in the art in the process of manufacturing the device. Accordingly, the detailed description thereof will be omitted.

Next, constructions for detecting the rotational position of the image sensor 241 using the magneto-resistance sensor are schematically illustrated in FIG. 5. The resistance value of the magneto-resistance sensor changes depending upon change of a magnetic field within a detecting area. By way of using such features, it is possible for the camera lens assembly to detect the rotational position, i.e., the photographing direction of the image sensor 241.

Constructions for detecting the photographing direction of the image sensor 241 using the magneto-resistance sensor are provided at the first and second driving part. More specifically, the first and second supporting members 221 and 231 are provided with the magneto-resistance sensors. The first and second moving members 255 and 265 are equipped with the magnetic substances. An exemplary embodiment, where the first supporting member 221 and the first moving member 255 are provided with first magneto-resistance sensors 291 and a first magnetic substance 293, respectively, is illustrated in FIG. 5.

Here, the first magneto-resistance sensors 291 are installed in pairs with a predetermined spacing therebetween. The number of the first magneto-resistance sensors 291 to be disposed in the first supporting members 221 can be properly adjusted. In other words, only one of the first magneto-resistance sensors 291 or three or more first magneto-resistance sensors 291 may be installed according to the size of the detecting area of the first magneto-resistance sensor 291 and the length of the first driving shaft 251.

The first magnetic substance 293 is mounted on the first moving member 255, which can be selectively facing one of the first magneto-resistance sensors 291, while the first moving member 255 moves along the first driving shaft 251. When the first moving member 255 is displaced along the first driving shaft 251, the respective resistance values of the first magneto-resistance sensors 291 change. By using this feature, it is possible to detect the position of the first moving member 255. Hence, an incline of the rotation frame 203 with respect to the fixed frame 202 can be calculated by detecting the position of the first moving member 255. Further, the rotational position of the image sensor 241 which has been rotated about the first axis A1 can be calculated therefrom.

Similarly, even though it is not shown, an incline of the image sensor frame 204 with respect to the rotation frame 203 can be calculated by using the second magneto-resistance sensors disposed in the second supporting member 231 and the second magnetic substance mounted on the second moving member 265. Likewise, the rotational position of the image sensor 241 which has been rotated about the second axis A2 can be calculated therefrom.

Consequently, it can be appreciated that the rotational position of the image sensor 241 which has been rotated about the first and second axes A1 and A2 can be calculated by detecting the respective positions of the first and second moving members 255 and 265 being moved, even if the first and second driving parts are operated independently or simultaneously.

For instance, in the preferred embodiment of the present invention, an exemplary construction in which the camera lens assembly is provided with a separate housing is illustrated. However, there is no need to provide the housing if the fixed frame can be directly secured to the mounting position of the closed-circuit camera or the portable communication device.

Further, in the preferred embodiment, it illustrates a construction as an example that the driving power to operate the pan-tilt structure is generated by the piezoelectric element. In the alternative, another type of driving device such as a linear motor or the like can be employed, if the first and the second moving members can be constructed to be displaceable along the first and the second driving shafts.

Moreover, in an initial state when the rotation frame is not rotated, an exemplary construction is disclosed in which the rotation frame is surrounded by the fixed frame and the image sensor frame is surrounded by the rotation frame. However, the fixed frame can be configured to partially surround the rotation frame even in the initial state by manufacturing a portion of the fixed frame with an open type, provided that the rotation frame can be disposed in the fixed frame in a state capable of rotating about the first axis. Likewise, the rotation frame can be constructed to partially surround the image sensor frame even in the initial state by manufacturing a portion of the rotation frame with an open type, provided that the image sensor frame can be provided in the rotation frame in a state capable of rotating about the second axis.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A camera lens assembly, comprising:
a fixed frame;
a rotation frame disposed in the fixed frame and configured to rotate about a first axis;
an image sensor frame provided in the rotation frame and configured to rotate about a second axis;
a first driving part installed in the fixed frame and configured to rotate the rotation frame; and
a second driving part installed in the rotation frame and configured to rotate the image sensor frame, wherein the second axis extends in a direction perpendicular to the first axis.

2. The camera lens assembly as recited in claim 1, further comprising an image sensor mounted on the image sensor frame, wherein the light axis of the image sensor extends in a direction perpendicular to the second axis.

3. The camera lens assembly as recited in claim 1, further comprising an image sensor mounted on the image sensor frame, wherein in an initial state when the rotation frame is not rotated, the rotation frame is surrounded by the fixed frame, wherein the image sensor frame is surrounded by the rotation frame, and wherein the light axis of the image sensor, the first axis, and the second axis are arranged in a direction perpendicular to each other.

4. The camera lens assembly as recited in claim 1, wherein the fixed frame is fixedly secured to a housing of a portable communication device.

5. The camera lens assembly as recited in claim 1, wherein the first driving part comprises:
a first piezoelectric element disposed in the fixed frame;
a first driving shaft installed on the fixed frame, wherein the first driving shaft is configured to linearly move back and forth in a direction perpendicular to the first axis at a location spaced apart from the first axis; and
a first moving member coupled to the first driving shaft, wherein the first moving member is configured to move along the first driving shaft upon activation of the first piezoelectric element, and wherein the first moving member is connected with the rotation frame and is configured to rotate the rotation frame while moving along the first driving shaft.

6. The camera lens assembly as recited in claim 5, wherein the first driving part further comprises a first supporting member which extends in a direction perpendicular to the first axis from the fixed frame to support the first driving shaft.

7. The camera lens assembly as recited in claim 1, wherein the second driving part comprises:
a second piezoelectric element disposed in the fixed frame;
a second driving shaft installed on the rotation frame, wherein the second driving shaft is configured to linearly move back and forth in a direction perpendicular to the second axis at a location spaced apart from the second axis; and
a second moving member coupled to the second driving shaft, wherein the second moving member is configured to move along the second driving shaft upon activation of the second piezoelectric element, and wherein the second moving member is connected with the image sensor frame and is configured to rotate the image sensor frame while moving along the second driving shaft.

8. The camera lens assembly as recited in claim 7, wherein the second driving part further comprises a second supporting member which extends in a direction perpendicular to the second axis from the rotation frame to support the second driving shaft.

9. The camera lens assembly as recited in claim 1, further comprising a tilt sensor installed on the image sensor frame.

10. The camera lens assembly as recited in claim 9, wherein the tilt sensor is a bi-axial tilt sensor and is configured to detect a rotational position of the image sensor frame with respect to the first and second axes.

11. The camera lens assembly as recited in claim 6, wherein the first driving part further comprises a first magneto-resistance sensor installed on the first supporting member and a first magnetic substance mounted on the first moving member, and wherein the first magneto-resistance sensor is configured to detect the position of the first magnetic substance to detect the rotational position of the image sensor frame with respect to the first axis.

12. The camera lens assembly as recited in claim 8, wherein the second driving part further comprises a second magneto-resistance sensor installed on the second supporting member and a second magnetic substance mounted on the second moving member, and wherein the second magneto-resistance sensor is configured to detect the position of the second magnetic substance to detect the rotational position of the image sensor frame with respect to the second axis.

13. A camera lens assembly, comprising:
a fixed frame;
a rotation frame disposed in the fixed frame and configured to rotate about a first axis; and
an image sensor frame provided in the rotation frame and configured to rotate about a second axis,
wherein the second axis extends in a direction perpendicular to the first axis.

14. The camera lens assembly as recited in claim 13, further comprising:
a first driving part installed in the fixed frame and configured to rotate the rotation frame; and
a second driving part installed in the rotation frame and configured to rotate the image sensor frame.

15. The camera lens assembly as recited in claim 13, further comprising an image sensor mounted on the image sensor frame, wherein the light axis of the image sensor extends in a direction perpendicular to the second axis.

16. The camera lens assembly as recited in claim 13, further comprising an image sensor mounted on the image sensor frame, wherein in an initial state when the rotation frame is not rotated, the rotation frame is surrounded by the fixed frame, wherein the image sensor frame is surrounded by the rotation frame, and wherein the light axis of the image sensor, the first axis, and the second axis are arranged in a direction perpendicular to each other.

17. The camera lens assembly as recited in claim 13, wherein the fixed frame is fixedly secured to a housing of a portable communication device.

18. The camera lens assembly as recited in claim 14, wherein the first driving part comprises:
a first piezoelectric element disposed in the fixed frame;
a first driving shaft installed on the fixed frame, wherein the first driving shaft is configured to linearly move back and forth in a direction perpendicular to the first axis at a location spaced apart from the first axis; and
a first moving member coupled to the first driving shaft, wherein the first moving member is configured to move along the first driving shaft upon activation of the first piezoelectric element, and wherein the first moving member is connected with the rotation frame and is configured to rotate the rotation frame while moving along the first driving shaft.

19. The camera lens assembly as recited in claim 18, wherein the first driving part further comprises a first supporting member which extends in a direction perpendicular to the first axis from the fixed frame to support the first driving shaft.

20. The camera lens assembly as recited in claim 14, wherein the second driving part comprises:
a second piezoelectric element disposed in the fixed frame;
a second driving shaft installed on the rotation frame, wherein the second driving shaft is configured to linearly move back and forth in a direction perpendicular to the second axis at a location spaced apart from the second axis; and
a second moving member coupled to the second driving shaft, wherein the second moving member is configured to move along the second driving shaft upon activation of the second piezoelectric element, and wherein the second moving member is connected with the image sensor frame and is configured to rotate the image sensor frame while moving along the second driving shaft.
